(19) United States
(12) Patent Application Publication
(10) Pub. No.: US 2014/0339806 A1
(43) Pub. Date: Nov. 20, 2014

(54) Personal Thoughts Organizer

(71) Applicant: Gail Coppola Kreitzer, Randolph, NJ (US)

(72) Inventor: Gail Coppola Kreitzer, Randolph, NJ (US)

(21) Appl. No.: 14/120,290

(22) Filed: May 14, 2014

Related U.S. Application Data
(60) Provisional application No. 61/822,954, filed on May 14, 2013.

(51) Int. Cl. B42D 5/00; B42D 5/04; B42D 3/12

(52) U.S. Cl. CPC B42D 5/006; B42D 3/12; B42D 5/047
USPC 281/30; 281/15.1; 281/44

(57) ABSTRACT

The present invention provides a device capable of organizing, accessing and prioritizing a user's immediate, short-term and long-term thoughts and corresponding tasks. The device provides a plurality of customizable note recording areas, all displayed in single, visible planar location as a customizable thought flow organizer, which is used to quickly store and organize all of a user's thoughts and the corresponding resultant tasks as they relate to a particular area of the user's life. The device contains a sub-location note area within the single, visible planar location used to organize the most immediate tasks into a prioritized task plan. The benefit of this unique and intuitive system is that it allows a user to continuously and systematically record, organize, and update any and all tasks necessary to a particular thought and simultaneously assess and establish the most immediate such priorities, in one single location.

This application claims priority to Provisional U.S. Patent Application Ser. No. 61/822,954, filed May 14, 2013.

### FIELD OF THE INVENTION

The present invention provides a device capable of organizing, accessing and prioritizing a user's immediate, short-term and long-term thoughts and corresponding tasks. The device provides a plurality of customizable note recording areas, all displayed in single, visible planar location as a customizable thought flow organizer, which is used to quickly store and organize all of a user's thoughts and the corresponding resultant tasks as they relate to a particular area of the user's life. The device contains a sub-location note area within the single, visible planar location used to organize the most immediate tasks into a prioritized task plan. The benefit of this unique and intuitive system is that it allows a user to continuously and systematically record, organize, and update any and all tasks necessary to a particular thought and simultaneously assess and establish the most immediate such priorities, in one single location.

### BACKGROUND

Personal organizers are known. For example, U.S. Pat. No. 5,294,208 discloses a notebook-type personal organizer comprises a multi-ring binder to which a plurality of leaves is connected. Plastic bags are connected to the binder, and each bag contains a pad of adhesive-backed paper sheets. The bags are adhered to a stiff posting sheet by means of a releasable adhesive to keep the bags from sagging and tearing. The user removes the pads from the bags and inserts them into pockets formed in a front panel of the organizer. Once a note is written on a paper sheet, the paper sheet can be removed from the pad and then adhered to the posting sheet for future reference. The posting sheet can be removed from, and inserted onto, the binder rings without opening those rings, and can be used as a straight edge or a distance-measuring ruler, and also to mark the proper day among the calendar pages of the organizer.

In another example, U.S. Pat. No. 5,405,169 discloses a book cover and binding that provides for “windowing” leafs of various types which retain their face and perimeter orientation when repositioned with respect to their host binder, including leafs with pluralities of surfaces, leafs with arrays of stacked repositionable notes, leafs with notepads, leafs with arrays of clips, and the like. The invention further provides for the binding of leafs which themselves may be electronic modules, each acting as a means for one of capturing, storing, accessing, displaying, and transmitting information in electronic form. Further, binding system cover is provided which offers a ring binding mechanism that is simple, light weight, and of a closed loop design available in various application specific shapes. Leaves and mounting surfaces according to the invention provide semi-permanent retaining means which enable easy removal and reinsertion, permitting rapid reordering, while retaining their semi-permanent binding during the page turning operation, independent of the weight of the mounting surface, any force orthogonally inward or outward with respect to the host coupling structure, and any position it may take in turning as it twists over its coupling structure, and to book systems formed by combining covers, rings, and mounting surfaces according to this invention that offer compact, reconfigurable, highly visual means for handling heterogenous, mixed media forms of information.

In another example, U.S. Pat. No. 6,036,395 discloses a reusable adhesive based notebook organizer that conveniently holds loose notes, papers and other similar items within the notebook.

In another example, U.S. Pat. No. 8,083,429 discloses a modular locking binder system having a channel coupled to the binder spine. The channel has an open end and a constricted region. A channel block is located at the open end of said channel and is configured to block and unlock the channel opening. The modular locking binder system is configured to removably hold a document module within the channel. The document module includes a module spine having a widened portion configured to operatively engage and be restrained by the constricted region of the channel. By either obstructing or un-obstructing the channel with the channel block, it is possible to removeably secure the document module within the channel when the widened ends of the document module are operatively engaged and restrained by the constricted portions of the channel.

In another example, U.S. patent application Ser. No. 10/123,760 discloses a system for organizing and storing information in a plurality of different categories having a plurality of binders wherein each binder is used to hold and store information for a particular category. A plurality of envelopes are removably stored within each binder. Each envelope is used to hold a sub-category of information related to the particular category of the binder which the envelope is removably stored.

In another example, U.S. patent application Ser. No. 13/568,514 discloses an organizer comprising a unique structural configuration to house and store both non-perforated documents and perforated documents. The organizer comprises a ring binder that is associated with an expandable compartment that is arranged peripheral to the ring binder.

Electronic embodiments of organizers are known. For example, U.S. Pat. No. 5,237,651 discloses an electronic personal organizer that electronically displays graphics representative of pages of a loose-leaf booklet or binder arranged into various sections on a display screen, including user selectable operational modes allowing input and storage of user generated graphics, notes, addresses, messages, etc. onto the representative pages. User input to the organizer is accomplished through a stylus ad an input tablet or transducer pad sensitive to pressure or position of the stylus, the organizer including a microprocessor for controlling the organizer, permanent and temporary internal memory along with external interfaces for connection with additional storage devices, printers, or other dumb or smart peripheral devices.

In another example, U.S. Pat. No. 6,613,101 discloses a method and apparatus for organizing information in a computer filing system. The method and apparatus include the creation of a pile comprising a collection of documents and displaying a graphical representation of the collection of documents. The method and apparatus further include browsing the collection of documents by pointing a cursor at a particular item in the collection of documents to reveal an indicia for the particular item in the collection of documents. The filing system can .automatically divide a pile (e.g. a collection of documents from an electronic mail network) into subpiles on the basis of the content of each document in the pile, and the filing system at the users request can automatically file away documents into existing piles in the computer system on the basis of a similarity match between the content (or other internal representation) of the document and the content (or other internal representation) of existing piles in the computer system. The filing system can also create a pile from a sample document by using the internal representation of the document as the internal of the new pile. The computer filing system provides various interfaces in connection with piles to the user of the system to provide feedback and other information to the user, including information concerning the documents and piles in the computer filing system.

In another example, U.S. Pat. No. 6,766,329 discloses a dynamic and personalized system for organizing data. The system provides users the ability to organize addressable information by creating associations between the information independent from the information and from any other previously imposed organization of the information. The associations contain trigger and target addresses, and relationships between the data. A view in the association identifies how to interpret the relationship. Tools are provided to manage the associations, and several applications of the organization system are described such as associating personal notes, serial construction of documents, compound construction of documents, and group construction of documents.

In another example, U.S. Pat. No. 8,312,059 discloses digital information objects in a digital information space are linked through the use of an overlay. A dynamic association between an accessed digital information object and each concept node in the overlay is established if the accessed digital information object and the overlay include at least one common concept. Links to other digital information objects are displayed if those objects are represented by information nodes within the overlay linked to a concept node expressing a common concept. At least a portion of the overlay may be exported for incorporation into other overlays or for various information processing functions.

In another example, U.S. Pat. No. 5,806,079 discloses a system and method of manipulating notes linked to data objects, and of manipulating the data objects. The method operates by displaying a note including one or more first sub-notes and one or more second sub-notes. The first sub-notes are linked to portions of a first data object associated with a first application. At least some of the first portions may be partially overlapping. The second sub-notes are linked to portions of a second data object associated with a second application. The second application is different from the first application. A request is received from a user viewing the note to display a portion of the first data object linked to a particular one of the first sub-notes. The first application is invoked, if the first application is not already invoked. The first application is caused to load the first data object and present the portion of the first data object linked to the particular one of the first sub-notes

Thoughts may be triggered by any number of stimuli and can occur at any moment on any given topic and often times occur sequentially on a multitude of topics. Thoughts occur that, in order to be effective, require action, sometimes immediate and sometimes preferable to be strategically organized for later action. Sometimes a given thought may have current priority but an intervening thought may supplant that priority. In the absence of a proper recording and organization tool, prior or lesser priority thoughts may be forgotten and never acted upon resulting in a later emergency. For example, a slight twinge of tooth pain may be the stimulus that triggers the thought that it would be a good idea to schedule a near term dentist appointment. It may not be possible or desirable to interrupt the current activity to schedule the dentist appointment at that moment. There is no date and time yet where such an appointment may be recorded because it has not been made yet. The only thing that has occurred is the thought identifying the need. If that thought is not recorded, and recorded in a way where it will be revisited, and tooth pain is subsided such that there is no other reminder, the dental appointment may never get made until it is an emergency. In another example, the tooth pain may be bad enough that you begin driving right to the dentist without an appointment. However, on the way, a phone call comes in that your son had an accident at school and you change course in spite of the tooth pain to go to your son. In that intervening time, the tooth pain then subsides and you forget about it. However, if all thoughts, those requiring immediate action, near term action and far term action all get recorded, and recorded in a way so as to organize their priority simultaneously with their recording, a life's action plan is also generated.

Moreover, as soon as a thought has occurred, another stimulus (for example, driving home past the peeling fence in the yard) may trigger another thought (need to paint fence) identifying another task that needs to get done. If that thought is not recorded, and recorded in a way where it will be revisited, the thought may prove worthless (fence does not get painted until it is rotting and needs to be replaced, instead of the easier task of merely painting it and thereby preserving it).

A time-honored way to address the foregoing is to have a piece of paper or a voice recorder to simply jot down all of these randomly occurring thoughts. Alternatively, some try to attach a specific date to a task hoping it is scheduled appropriately. However, in this manner, all recorded thoughts are as randomly recorded as they were generated or not prioritized correctly and can be as overwhelming to organize as they are to simply remember in the first place. A calendared low priority task may prevent the later occurring thought, but higher priority task from being appropriately calendared. There is no organizer that provides a central place to record ideas in a singular visible location. Traditional planners and organizers do not enable recording and visualization of the full scope of thoughts and to-do tasks in a singular visual location which hinders prioritization.

The devices of the current state of the art do not solve these problems of personal organization. While many of the devices noted herein provide places to organize thoughts, they all require at least one extra organizational step at the time of recording, i.e., the quickness and ease of recording in a single location, a requirement to effectively be able to record and prioritize, is encumbered with a need for inclusion of at least one simultaneous extra organizational step separate and apart from the recording step. Such an extra step may be turning to the page in the organizer where a particular thought category would be recorded and then having to turn to another page where a different thought category needs to be recorded. This flipping back and forth makes the recording process more daunting than it needs to be and also makes it impossible to view all such thoughts at once to create a task prioritization. This in turn decreases the effectiveness of current personal organizers. Moreover, the electronic devices noted either provide an electronic version of what is physically available or utilize computer algorithms to manipulate already entered information, but do not provide the functionality of entering the random data in a single location in an initially organized manner as is described herein. The electronic embodiment described herein is the exact same organizational process described in detail, but using the power of known electronics to carry out the actual transcribing from thought to recorded and organized task.

Therefore, there remains an unmet need for the device of the present invention that provides the ability to quickly record any random thought triggered by any stimuli requiring immediate, near term or long term action, in a single location in an organized manner allowing instant recognition of interrelationships resulting in easy prioritization of tasks.

### SUMMARY

The present invention provides a device capable of organizing, accessing and prioritizing random thoughts as they occur in a person's mind or while reviewing such recorded thoughts and an upcoming calendar of events, notwithstanding whether such thought requires immediate term action (pick up milk on the way home because we are out); near term action (schedule a haircut); or a long term action (plan a night out for a friend). This is accomplished by providing a single location as a customizable thought flow organizer, console with a plurality of sub-location note areas allowing thoughts to be recorded into categories. Once populated with thoughts, it is easy to assess the top priority tasks associated with those thoughts and develop a prioritized task plan because all information is viewable and comparable in a single location. Additionally, within this single location, one sub-location becomes the “Hit List” or the list which contains the filtered immediate or near term tasks that have the highest immediate priority. The device of the present invention may be embodied in a physical “paper” medium or other suitable surface area for recording written notes or an “electronic” medium, i.e., a computer or tablet based application.

The benefit of this unique and intuitive system is that it allows a user to continuously and systematically record; organize, and update any and all tasks and simultaneously assess and establish the most immediate such priorities, in one single location.

The present invention provides a solution to the unmet need, by providing a personal organizer comprising:
a. a front and rear panel;
b. a first surface inside said front panel; and
c. a plurality of customizable recording areas positioned within said first surface; wherein
   i. said customizable recording areas are capable of recording thoughts in a single planar and visible location in an organized manner; wherein
   ii. such recordings of thoughts are used to generate a prioritized task plan.

Alternatively, the present invention provides a solution to the unmet need, by providing an electronic personal organizer comprising:
a. a graphical user interface;
b. a display screen that simulates a plurality of repositionable note pads creating a plurality of sub-location note taking areas; wherein
   i. said sub-location note taking areas are capable of recording thoughts in a single visible location in an organized manner; wherein
   ii. such recordings are used to generate a prioritized task plan.

There are many alternative embodiments to the device of the present invention described elsewhere herein.

For example, the first surface for placement of the plurality of customizable recording areas (which may be embodied in repositionable note pads) may be located anywhere within the personal organizer capable of creating a single visible location convenient to the user.

In one embodiment, the customizable recording areas could be repositionable note pads or spiral bound note pads or any other small note surface suitable to the purposes as described herein.

In another embodiment, there can be an at least one other area of paper for note taking which may also include such features as a calendar or a calculator.

In another embodiment, the calendar would be easily retrieved from its placement area to expand and modify the area of the single location where the customizable recording areas or repositionable note pads are used for recording thoughts and tasks.

In an electronic embodiment, the configuration, color and size of the plurality of sub-location note taking areas may be located at anywhere within the screen of creating a single location convenient to the user.

In another electronic embodiment, the sub-location note taking areas could be replaced audio inputs for recording voice instructions into written notes.

In another electronic embodiment, there can be an at least one other file area for note taking which may also include such features as a calendar or a calculator.

In another electronic embodiment, the calendar file would be easily retrieved from its storage area to overlay and modify the area of the single location where the sub-location note taking areas are used for recording thoughts and tasks.

It will be appreciated by one of skill in the art the many applications of the device of the present invention and should not be limited by the examples presented herein. For example, and not by way of limitation, any typically found feature of existing personal organizers may be incorporated for use with the inventive features of the organizer described herein. Similarly, any existing organizer may be modified to incorporate the inventive device of the present invention. Additionally, and not by way of limitation, any typically found feature of existing physical personal organizers as well as any typically used computer software and hardware functionality may be incorporated for use with inventive features of the device described herein

### BRIEF DESCRIPTION OF THE DRAWINGS

FIG. 1 shows one embodiment of the present invention wherein a plurality of repositionable note pads (1) are mounted on the inside cover (2) of a personal organizer. Also featured are a writing implement (3) mounted with a mounting loop (4).

FIG. 2 shows one embodiment of the present invention showing an expandable single location surface area created by utilizing the front surface area of the other area for note taking (5) to expand the number of sub-locations by affixing additional repositionable note pads (1) such that when the device is opened, the single location containing the sub-locations is two pages of surface area, i.e., the inside front cover as demonstrated in FIG. 1, plus this adjacent area.

FIG. 3 shows one embodiment of the present invention as it might be used by an attorney assigning areas of thought categories such as “Litigation”; “Contract Review”; “Meetings”; and “Messages” (11) to certain sub-location areas with one prioritized task list designated the “Hit List” (12).

FIG. 4 shows one embodiment of the present invention as it might be used by a Mom assigning areas of thought categories such as “Husband”; “Household”; “Kids”; and “Volunteer” (11) to certain sub-location areas with one prioritized task list designated the “Hit List” (12).

FIG. 5 shows one embodiment of the present invention wherein a plurality of other tabbed (6) note taking areas (5) are disposably and replaceably mounted in the personal organizer by inserting prepunched hole areas (8) through mounting rings (7).

FIG. 6 shows one embodiment of one example of a possible configuration of the other note taking areas indicating the use of a calendar (13).

FIG. 7 shows one embodiment of the present invention using one of the other areas for note taking for recording more detailed notes about a subject of one of the sub-location thought areas contained in the single location.

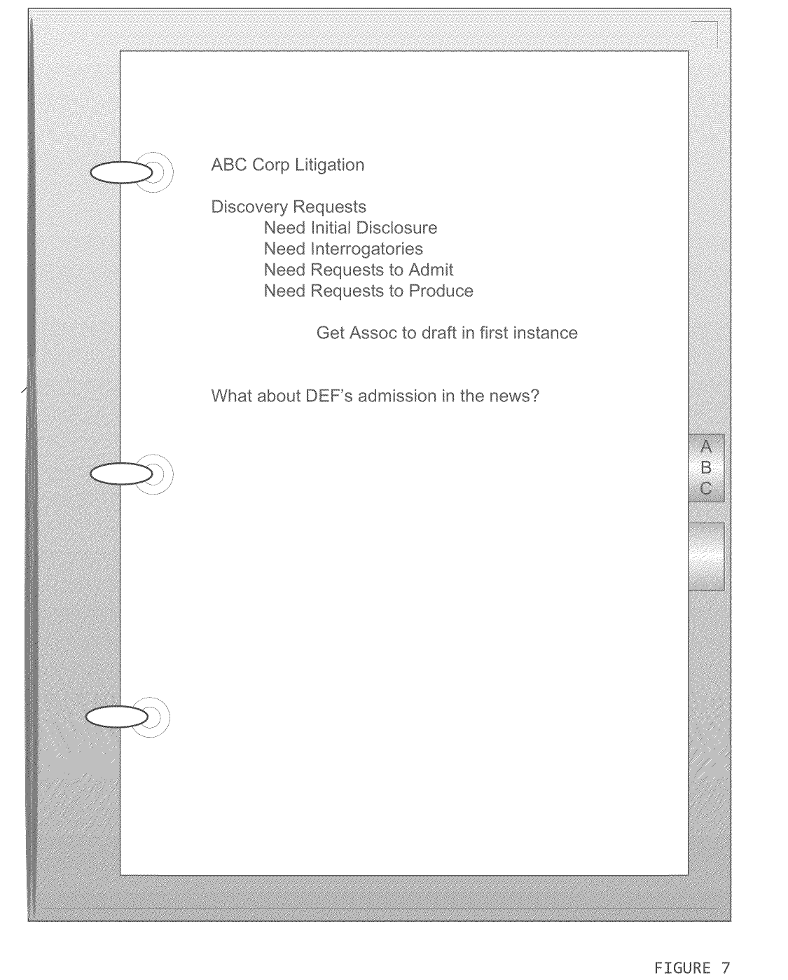

FIG. 8 shows one embodiment of the present invention for mounting any of the plurality of repositionable note pads (1) with the use of hook and loop fastener material with one side of such fastener material (9) affixed to the underside of the repositionable note pad (1) and adhering such to the other side of the fastener material (10) pre-mounted to the mounting location (2) on the personal organizer.

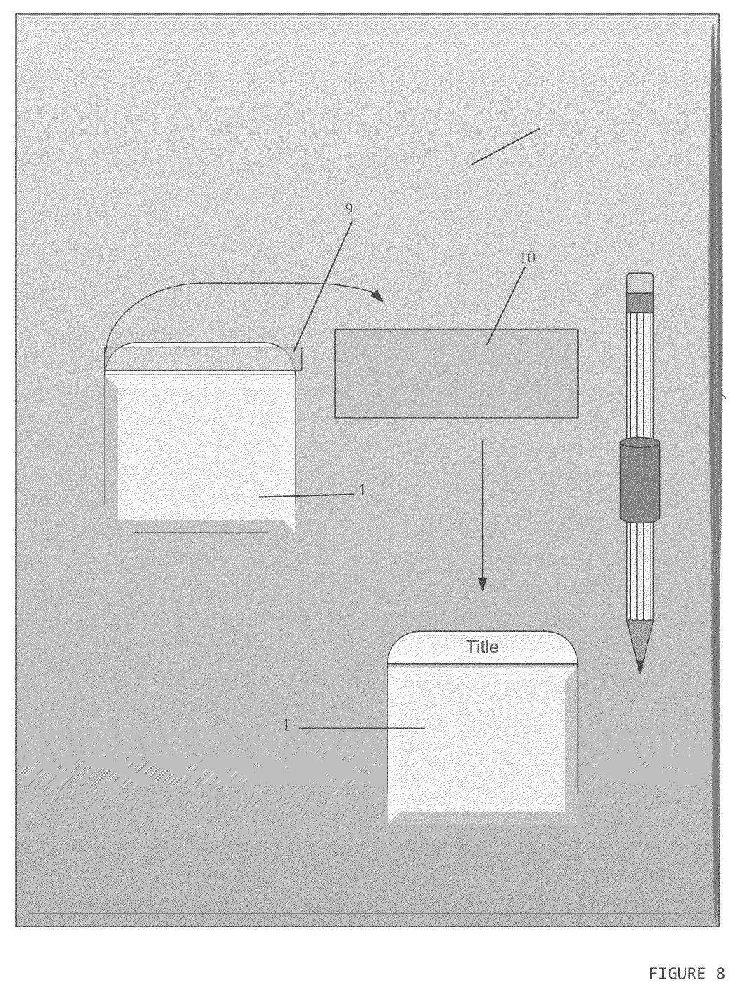

FIG. 9 shows one embodiment of the present invention for mounting any of the plurality of repositionable note pads (1) with the use of a stud and tube coupling system wherein the page contains either the stud or tubes and the repositionable note pads (1) contain the corresponding tube or stud to mate with that contained on the page.

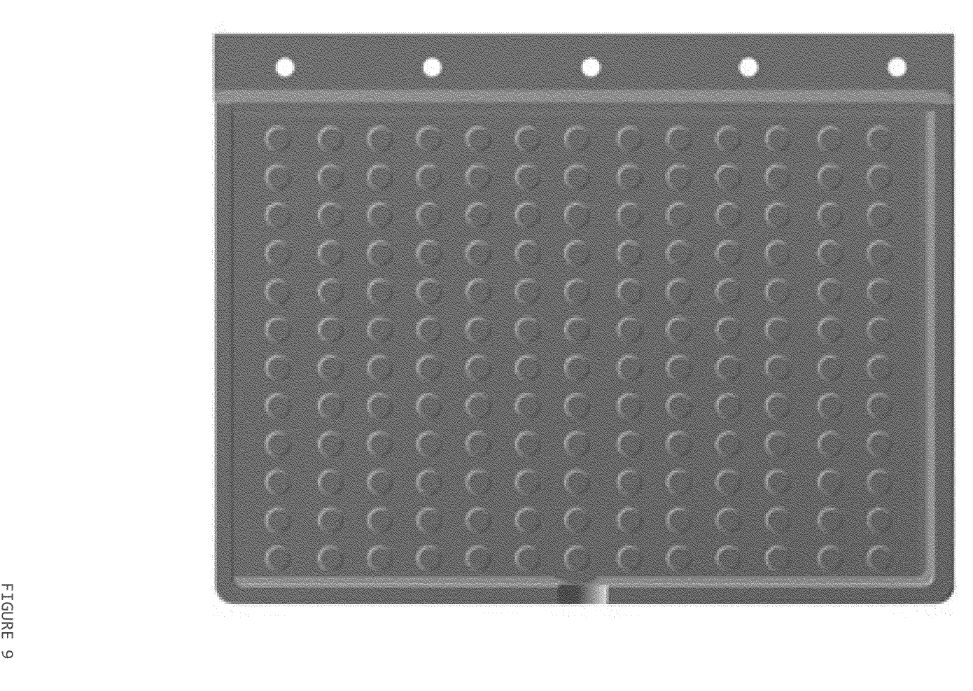

FIG. 10 shows one embodiment of the device of the present invention utilized in connection with a commonly available electronic tablet device (21) indicating the icon (23) on the device's graphical user interface (22) that is used to open the application of the present invention.

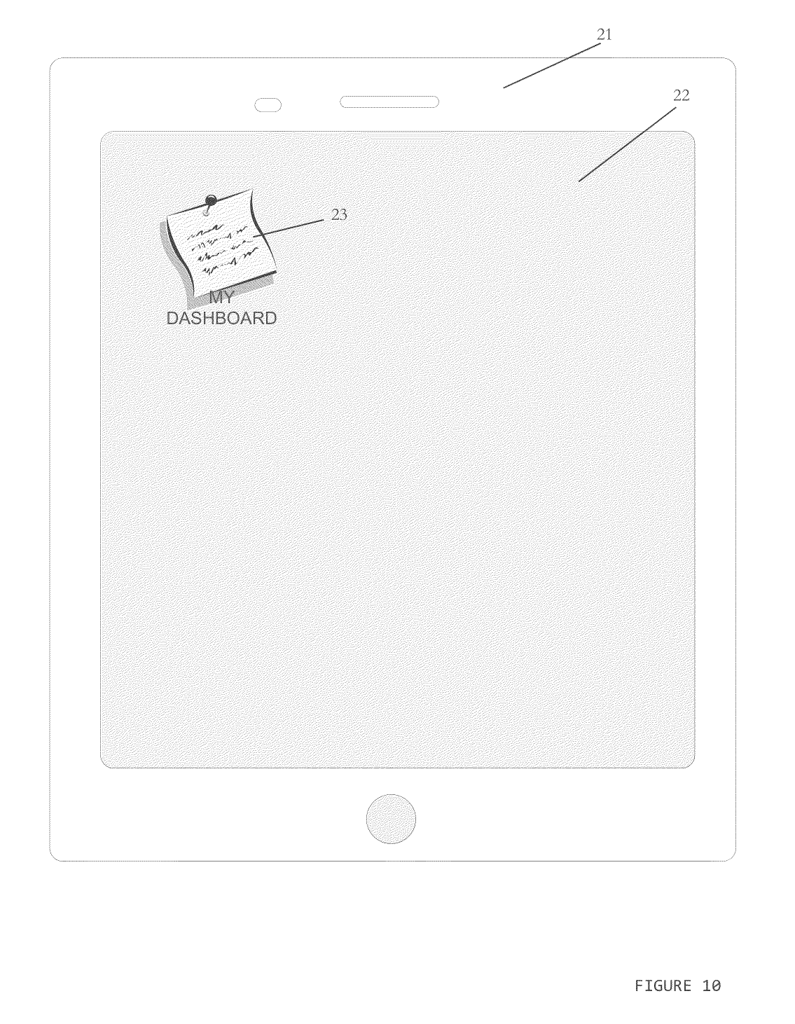

FIG. 11 shows one embodiment of the device of the present invention after the application opens showing electronic simulations (24) of the repositionable note pads (1) of the physical manifestation of the device of the present invention representing sub-location note taking areas.

FIG. 12 shows one embodiment of the device of the present invention showing the electronic sub-location note taking areas (24) corresponding to the repositionable note pads (1) of the physical manifestation of the device of the present invention being used to record notes about thoughts in the same manner as the physically manifested device. Here, there is an electronic link (25) to a file showing more detail.

FIG. 13 shows one, embodiment of the device of the present invention showing the electronic device screen representation when a particular link in the single location screen is followed to another file area (26).

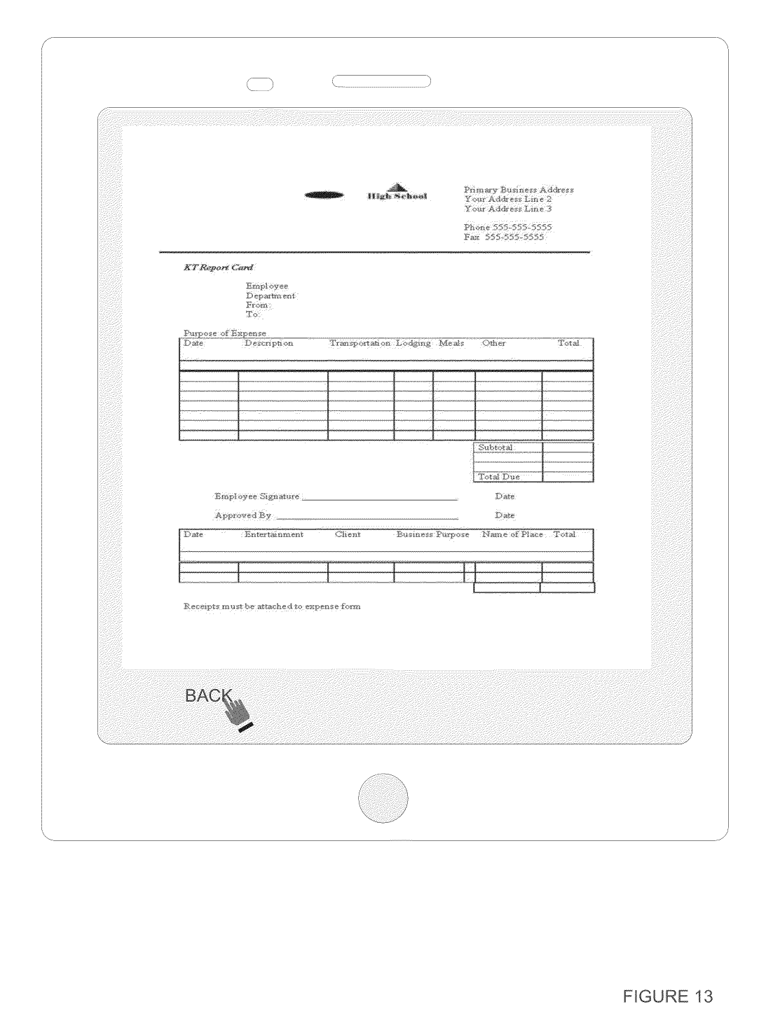

### DETAILED DESCRIPTION

For clarity of disclosure, and not by way of limitation, the detailed description of the invention is divided into the following subsections that describe or illustrate certain features, embodiments or applications of the present invention.

### Definitions

“Personal organizer” as used herein refers to any notebook or diary where a user may record information personal to him or her. While personal organizers typically include areas for a calendar, recording names, addresses, phone numbers, appointments and the like, as used herein, the absence of any such feature does not remove it from the definition.

“Repositionable note pad” as used herein refers to one or a plurality of small note papers with an adhesive edge that allows such note paper to be attached and removed from other such small note papers or other surfaces multiple times.

“Binder” as used herein refers to a flexible system of securing loose leaves of paper allowing for them to be removed and reinserted. Such systems include, among others a ring system and a clamp system.

“Single location” as used herein refers to a single, relatively planar surface area, easily viewable without hidden areas, but is not meant to be limited to a single loci or area within said relatively planar surface area and may also be stated herein as a “single visible location” for clarity.

“Sub-location” as used herein refers to a specific loci or area within a single location where actual notes are recorded in response to a thought.

“Electronic device” as used herein refers to any computer or device having a graphical user interface capable of implementing software and allowing a user to interface with the software through the graphical user interface.

“Electronic personal organizer” as used herein refers to any electronic device that is capable of functioning as a personal organizer.

“Sub-location note taking area” as used herein in connection with electronic personal organizers refers to the specific area within a graphical user interface where electronic representations of repositionable note pads occur for use by the user to record notes.

“Graphical user interface” as used herein refers to a display screen on or connected to an electronic device that allows a user to interact with the electronic device.

### The System of the Present Invention

In one embodiment, the present invention provides a personal organizer comprising:
a. a front and rear panel;
b. a first surface inside said front panel; and
c. a plurality of customizable recording areas positioned within said first surface; wherein
   i. said customizable recording areas are capable of recording thoughts in a single planar and visible location in an organized manner; wherein
   ii. such recordings of thoughts are used to generate a prioritized task plan.

In one embodiment, the customizable recording areas are enabled by the use of repositionable note pads.

In an alternative embodiment, the present invention provides an electronic personal organizer comprising:
a. a graphical user interface;
b. a display screen that simulates a plurality of customizable recording areas creating a plurality of sub-location note taking areas; wherein
   i. said sub-location note taking areas are capable of recording thoughts in a single planar location in an organized manner; wherein
   ii. such recordings of thoughts are used to generate a prioritized task plan.

In one embodiment, the present invention provides a plurality of repositionable note pads in a single location, each assigned by the user with a category that represents a distinct thought area for that user. In one embodiment, there can be any number of repositionable note pads of varying sizes, shapes and colors, required to sufficiently represent the various distinct thought areas for that user

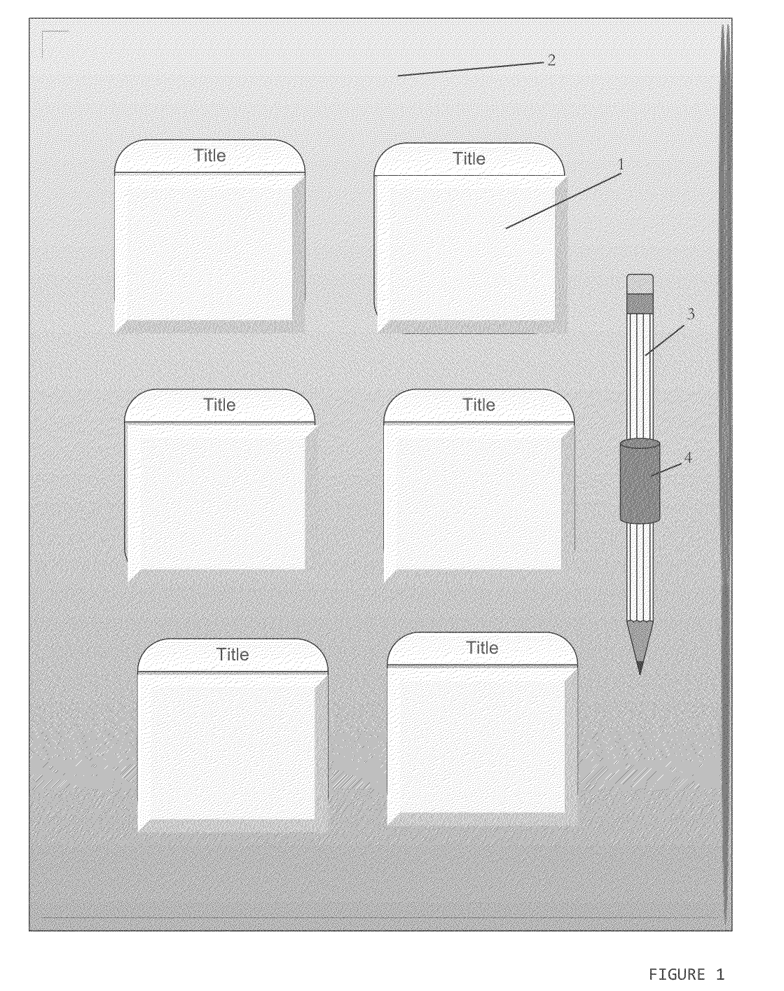

For example, where the word “Title” appears on each repositionable note pad represented in FIG. 1, the user would label such repositionable note pad, either physically or mentally, with a distinct thought area. For example, if the user was a stay-at-home mom, a thought area might be “husband” where any thoughts pertaining to things that need to be discussed with her husband are recorded. Another thought area might be “household” where any thoughts that occur pertaining to things involving the house and its maintenance are recorded. Another thought area might be “to buy” where any thoughts that occur pertaining to things that are needed to be bought are recorded.

The key is, that no matter what thought occurs to the user at a given moment, there is a single location to turn to where the thought can be immediately recorded in sub-location resulting in an organized recording without having to file it in the traditional sense or immediately calendar it and the same single location becomes the place to turn to where the full scope of all thoughts can be seen in an organized manner at all times allowing the user to filter all such thoughts into a prioritized task plan.

Whereas typically available planners are calendar centric, i.e., when a thought occurs that a task needs to get done, it typically gets “calendared” right then and such task is fit into an available time slot without thinking about what other tasks it may now be prioritized over; the device of the present invention is thought centric, i.e., first record the thoughts and tasks that come to mind and then prioritize such that the prioritization is effective, not random. Thus, the first step is to empty the mind of cluttered thoughts by populating them into the single location console. However, instead of needing to know all priority about the task associated with a given thought in order to properly “calendar” it or “file” it; all you need to know is where it fits in within a range of topics or categories. Once the console is populated and the mind de-cluttered, the prioritization of these now categorized thoughts can be accomplished by easily viewing the one plane, completely visible console of thoughts. This immediate priority list guides the current, immediate or daily task to-do list. If some tasks require more serious effort, then a separate area within the planner can be set up for note taking on that special task which would then only be used when working on that task.

In one embodiment, users create and arrange their own unique set of categories into their console area to suit their own needs. All such repositionable note pads are customizable and replaceable. As certain thought areas are no longer needed, they can be removed and/or replaced and/or added to.

In one embodiment, the console is created by a thick clear plastic envelope or folder into which a template page of note taking areas is placed. The user would then use one page repositionable note pads to adhere to the outside of the plastic envelope or folder over each template guided area. In this manner, the user is guided into the proper operation of the device. As the one page repositionable note pads are filled up and used, they can be replaced with new such sheets.

In one embodiment, one repositionable note pad is deemed the “Hit List.” The Hit List pad contains all the immediate or near term things that must be done. For example, when a thought occurs that a certain task must be done today, it can be placed directly on the Hit List, whereas if the thought occurred that a certain task must be done sometime in the future, it can be placed on the pad designated for that thought area and not make it to the Hit List until it must be done that day or in the near term according to the user's preferences.

In one embodiment, the Hit List note pad looks different from any other repositionable note pad and can be easily detached and moved on to the front of the device such that it is immediately viewable without the need to even open the device.

In one embodiment, as thoughts are recorded onto repositionable note pads designated for certain thought areas in a sub-location within the single location, they are assessed a priority level. As many such thoughts accumulate, the highest priority thoughts are filtered into the Hit List repositionable note pad thought area so that a strategic thoughts and prioritized actions task list is developed insuring that the most pressing tasks of the moment are addressed according to their order of priority.

In one embodiment, the user would have a thought, open the device of the present invention and record the thought in its assigned thought area repositionable note pad located at a sub-location within the single location. After a number of such thoughts have occurred and been recorded, the user would review and put on the Hit List pad the most pressing of those thoughts that needs attention. Alternatively, the user may simply record an immediate task thought on the Hit List directly.

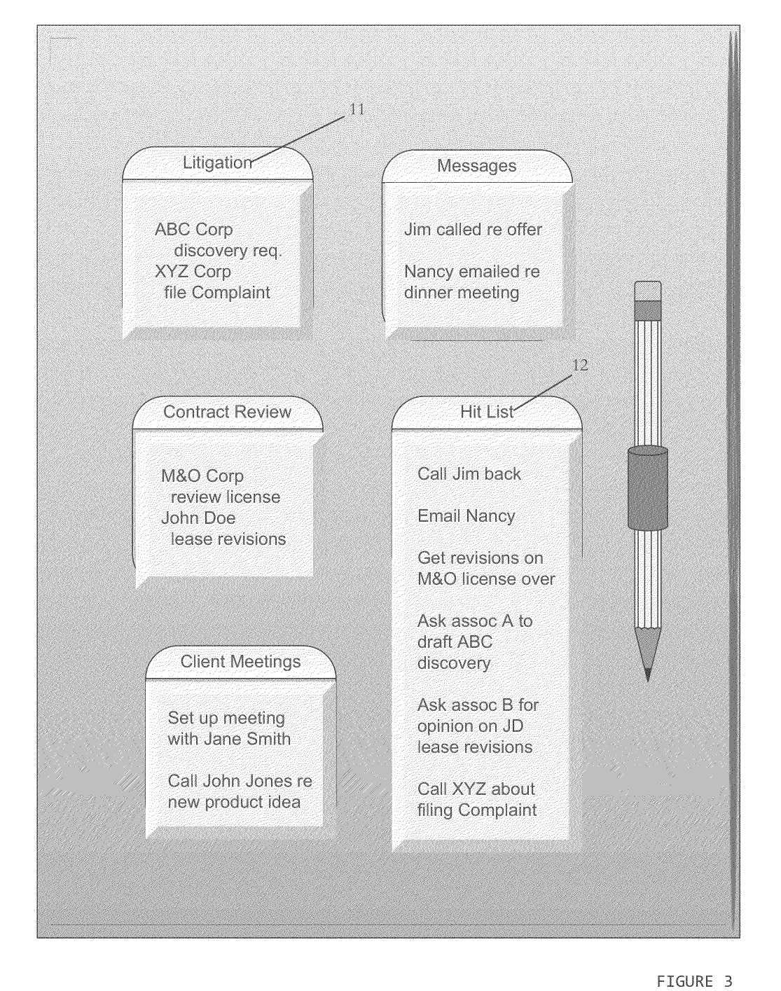

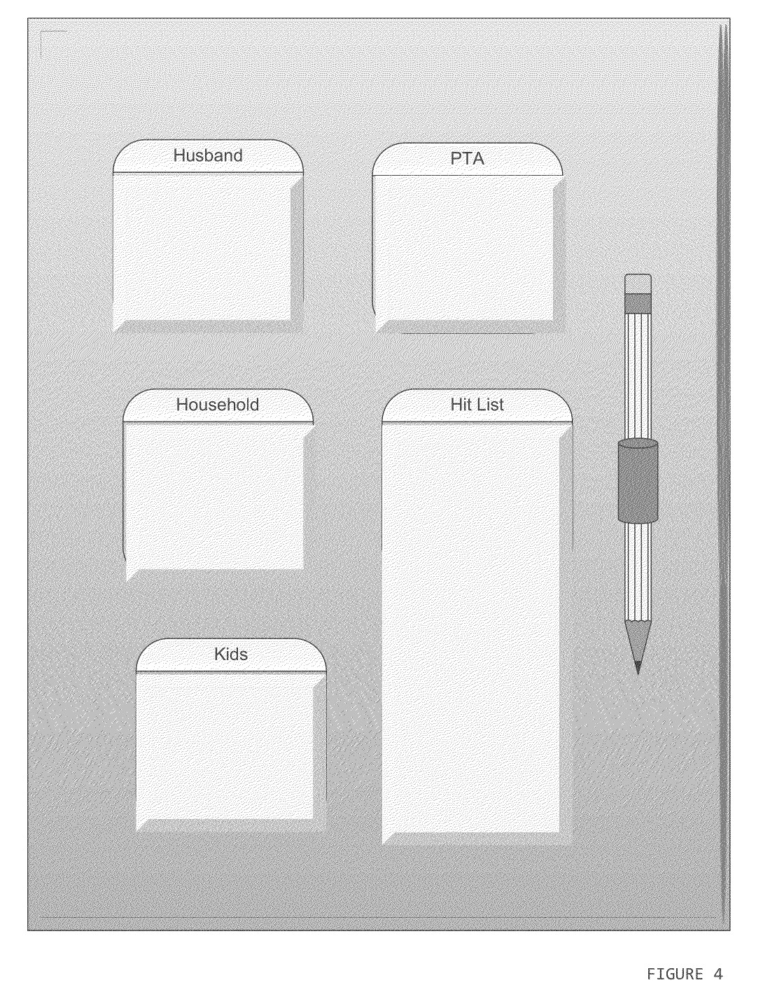

In one embodiment, as the user completes various tasks or otherwise addresses the thought recorded on any pad, the user would cross out that recorded thought (see FIGS. 3 and 4). This allows for easy updating and modifying. Long lists of tasks do not need to be re-copied. Adding, crossing off and modification can occur within any list. However, at any time that it becomes desirable, the top sheet may be removed leaving a clean note area underneath to begin anew and only copying the necessary remaining tasks, if any. Alternatively, if a single sheet repositionable note pad is used, for example, with the plastic folder embodiment noted above, the single sheet could be replaced with a new single sheet from a supply stored within another area of the device.

In one embodiment, any repositionable note pad is also replaceable.

In one embodiment, there could be multiple consoles, i.e., a separate single location for certain complicated and extensive thought areas. In one embodiment, when there are multiple consoles, there would be one master console with one or more sub consoles.

In one embodiment, the at least one other area for note taking is used for more in-depth notes, thoughts and information relating to a given thought or task.

In one embodiment, a thought that occurs to a user may trigger a need for more complex actions. Nevertheless, the initial thought is recorded in its designated thought area. For example, the stay-at-home mom may record the thought, “discuss beach vacation” on the pad labeled, “husband.” Later that day, when she is with her husband and reviewing her recorded thoughts, she discusses the idea of planning a family beach vacation and they decide it's a good idea and should begin planning in earnest. At that moment, the stay-at-home mom may need a new repositionable note pad for the thought area “vacation.” Moreover, there may be a need for a tabbed area in another area of the device for note taking that is devoted for information regarding the beach vacation. The next day, the thought may occur to find appropriate hotels. It should be recorded on the repositionable note pad labeled, “vacation” to “find appropriate hotels.” Later, when researching hotels according to that recorded thought, various hotels and their amenities, prices, availability and the like can be recorded in the other area of the device for note taking devoted to information regarding the beach vacation. The thought “find appropriate hotels” could be crossed off the “vacation” repositionable note pad area and the item “book hotel” added to such area or the Hit List.

Thus, the present invention provides a device that can capture and organize all thoughts that occur to a user creating a single location viewable area of all tasks, whether it is an immediate task (pick up milk for dinner); an intermediate task (schedule a haircut); or a long term task (plan a night out for a friend); such that all of these tasks may be prioritized into a single Hit List of tasks to accomplish. This console provides a place to store all thoughts and allows easy recognition of priority to develop a customized, prioritized task plan.

For example, during the course of a person's day, in this example, a Mom user of this device, may think of several topics of discussion for their spouse (Are the passports up to date for the upcoming vacation? Do you want to have dinner next Saturday with the Smiths? What do you think about purchasing new patio furniture? etc.) They all can be recorded in a designated sub-location note area on the console as all things “Spouse” related and continue adding to the list as other thoughts occur. During the same day, this Mom may think about several things pertaining to their house (It's time to paint the fence. We need a new rug for the foyer. The outside light bulbs along the walkway are out and need to be replaced. etc.) These thoughts would be recorded in the designated sub-location area on the console as all things “House” related. As this Mom creates her own, unique console of categories with specified tasks and ideas, she will begin to assess the totality of endeavors she wants to accomplish and begin to realize what can be accomplished today, tomorrow, next week and create an optimal, prioritized task plan. The console is flexible and customizable with replaceable and repositionable note pads such that this Mom can easily modify the tasks listed within any category, create new categories, delete decidedly trivial thoughts and easily create, modify, re-create, and update a prioritized task plan.

Thoughts and their corresponding tasks are fluid and random in nature and reflect varying degrees of time-sensitivity. The device of the present invention allows a user to begin thought organization the moment thoughts are triggered and still capture the thoughts in a single location and allows the user to easily update tasks as things change (a task is complete or a thought occurs that some task, is a higher priority than what was going to get done), i.e., a user may constantly assess their optimal prioritization within the console framework.

In one embodiment, other areas of the device for note taking may contain an easily detachable and replaceable calendar insert. In one embodiment, this calendar insert would be for the upcoming month. In one embodiment, this calendar insert would be for the upcoming year. In one embodiment, this calendar insert could be for any useful period of time to the user.

In one embodiment, the calendar insert would be positioned within a pocket in the other area for note taking such that it may be pulled out and viewed at the same time as viewing the single location such that the calendar essentially expands the zone of the single location maintaining the substantially planar single location surface area.

In one embodiment, the calendar insert would be completely removable such that it may be viewed alongside the console and/or removable Hit List or separately to facilitate appropriate updates and modifications and to achieve accomplishing calendared tasks. In one embodiment, once removed, the calendar would be easily replaceable for later use.

In one embodiment, when a thought that occurs to a user is recorded and that thought later triggers the making of some sort of appointment, the appointment is recorded on the calendar insert.

In one embodiment, each morning, the calendar insert is viewed and any number of immediate events that need doing are recorded on the Hit List. How far in advance events are recorded from the calendar insert onto the Hit List is user dependant according to that user's tendencies and preferences.

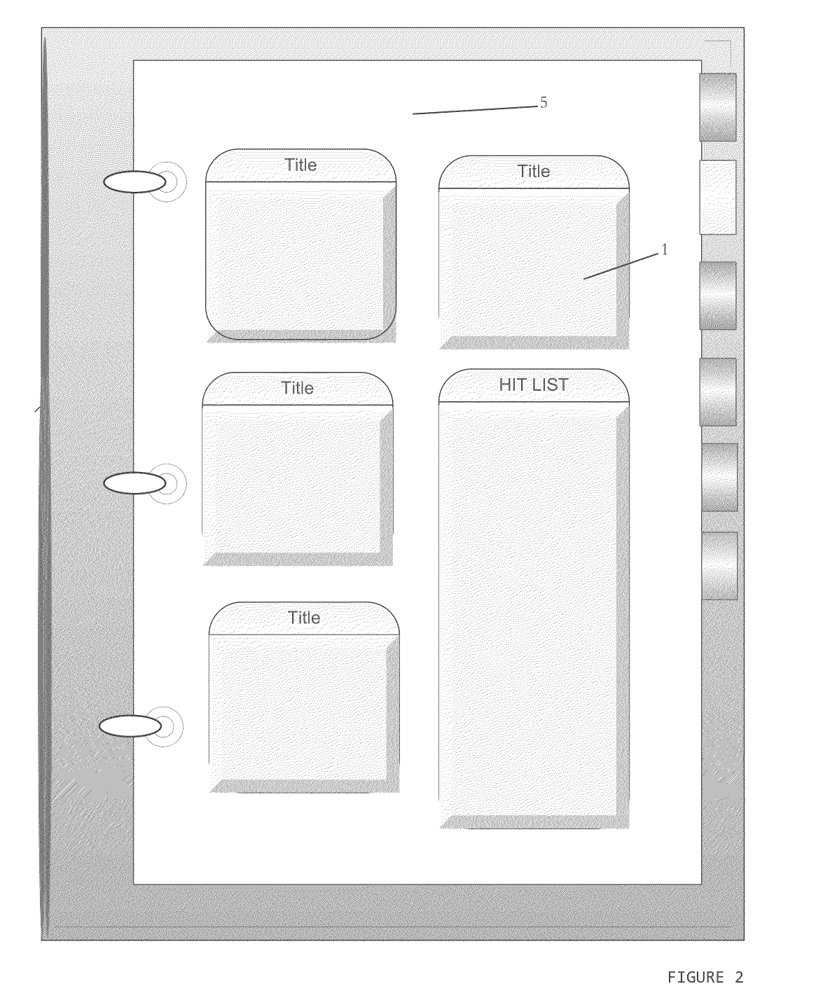

In one embodiment, there can be an overflow area for extra repositionable note pads for assignment to a user's designated thought area on the page adjacent to the inside front cover when the device of the present invention is open (see FIG. 4), i.e., on a page designed for mounting such extra repositionable note pads placed in front of the tabbed pages (5, 6) of the other area for paper for taking notes illustrated in FIGS. 2 and 4. In this embodiment, the overall integrity of the substantially planar single location for a plurality of repositionable note pads, each assigned to a thought area of a user, is maintained, but in effect, doubles the potential size of such area.

In one embodiment, the other area of paper for note taking could encompass any other feature of conventional personal organizers according to the preference of the user. By way of example and not limitation, such features could include, addresses, phone numbers, password reminders, contact lists, doctors and other specialist professional's information, maps, measures, expense sheets, holidays and the like.

In one embodiment, the plurality of repositionable note pads each assigned to a thought area of a user allows the user full visibility of all categories of thought processes in a single location which provides a place for all thoughts and is designed to allow the user to see the relationship between the thoughts and the related tasks to be done.

In one embodiment, the user is able to organize their thoughts and task to-do lists as soon as thoughts emerge and also as those thoughts are developed and further refined.

In one embodiment, the device of the present invention provides the flexibility to organize constantly changing and shifting tasks and the priorities of those tasks. The user has the opportunity to easily update and modify their categories as well as their Hit List tasks and day to day priorities.

In one embodiment, the device of the present invention allows a user to get everything out of their head as it forms without fear of losing important thoughts.

In one embodiment, the repositionable note pads could be replaced with spiral bound note pads or any other easily accessible suitable note surface of the proper size, shape and color.

In one embodiment, the user plans their tasks according to the categories of thoughts and the perceived priorities of the thoughts as recorded and then places those tasks into the calendar, i.e., the tasks are first category centric rather than calendar centric. In this manner, the truly pressing items of the day are prioritized and completed prior to lesser pressing items that, in the absence of this invention, might simply get scheduled according to an open calendar slot and ahead of something more pressing, but that gets thought of or emerges a little while later.

In one embodiment, the repositionable note pads are mounted to their mounting surface using hook and loop fastener, commonly sold under the brand name Velcro®, which allows for complete customization of size, location, numerosity and color of the note pads and also allows for easy and continuous updates and modification of the arrangements.

In another embodiment, the repositionable note pads may be mounted to their mounting surface using slits into which a cardboard backing inserts or a magnetic surface onto which an embedded magnet attaches.

In another embodiment, the repositionable note pads are mounted to their mounting surface using a stud and tube coupling system similar to the Legos® brand toy building bricks. Alternatively, single sheet repositionable note pads may be stuck to a reusable surface such as thick plastic sheets. Any suitable means for attaching known in the industry may be utilized.

All of the foregoing functionality may be reproduced and simulated to create corresponding functionality in the electronic expression of the device of the present invention. For example, in one embodiment, the present invention provides a plurality of sub-location note taking areas in a single location, each assigned by the user with a category that represents a distinct thought area for that user. In one embodiment, there can be any number of sub-location note taking areas of varying sizes and colors, required to sufficiently represent the various distinct thought areas for that user.

In one embodiment, one sub-location note taking area is deemed the “Hit List.” The Hit

List note area contains all the immediate or near term things that must be done. For example, when a thought occurs that a certain task must be done today, it can be placed directly on the Hit List, whereas if the thought occurred that a certain task must be done sometime in the near future, it can be placed in the sub-location note taking area designated for that thought area and not make it to the Hit List until it must be done that day or in the near term according to the user's preference.

In one embodiment, as thoughts are recorded onto sub-location note taking areas designated for certain thought areas within the single location, they are assessed a priority level. As many such thoughts accumulate, the highest priority thoughts are filtered into the Hit List sub-location note taking thought area so that a strategic thoughts and prioritized actions task list is developed insuring that the most pressing tasks of the moment are addressed according to their order of priority.

In one embodiment, the user would have a thought, open the device of the present invention and record the thought in its assigned thought area sub-location note taking area located within the single location. After a number of such thoughts have occurred and been recorded, the user would review and put on the Hit List pad the most pressing of those thoughts that needs attention.

In one embodiment, as the user completes various tasks or otherwise addresses the thought recorded in any sub-location note taking area, the user would delete that recorded thought.

In one embodiment, a separate file area contains a calendar function. In one embodiment, this calendar function would be for the upcoming month. In one embodiment, this calendar function would be for the upcoming year. In one embodiment, this calendar function could be for any useful period of time to the user.

In one embodiment, the calendar function would be positioned within an area of the single location and moveable such that it may be viewed in connection with any sub-location note taking area such that the calendar essentially modifies the zone of the single location.

In one embodiment, when a thought that occurs to a user is recorded and that thought later triggers the making of some sort of appointment, the appointment is recorded on the calendar function .

In one embodiment, each morning, the calendar function is viewed and any number of immediate events that need doing are recorded on the Hit List. How far in advance events are recorded from the calendar function onto the Hit List is user dependant according to that user's tendencies and preferences.

In one embodiment, there can be an overflow area for extra sub-location note taking areas by simply sliding the graphical display in one direction or another. In this embodiment, the overall integrity of the single location for a plurality of sub-location note taking areas, each assigned to a thought area of a user is maintained, but in effect, maximizes the potential size of such area.

In one embodiment, the other file areas for note taking could encompass any other feature of conventional personal organizers according to the preference of the user. By way of example and not limitation, such features could include, addresses, phone numbers, password reminders, contact lists, doctors and other specialist professionals information, maps, measures, expense sheets, holidays and the like, all accessible with one interaction on the graphical user interface and each capable of viewing alone or in conjunction with any sub-location note taking area.

In one embodiment, the plurality of sub-location note taking areas each assigned to a thought area of a user allows the user full visibility of all categories of thought processes in a single location which provides a place for all thoughts and is designed to allow the user to see the relationship between the thoughts and the related tasks to be done.

In one embodiment, the plurality of sub-location note taking areas each assigned to a thought area of a user allows'the user full visibility of all categories of thought processes in a single location which provides a place for all thoughts and is designed to allow the user to see the relationship between the thoughts and the related tasks to be done.

In one embodiment, the device of the present invention provides the flexibility to organize constantly changing and shifting tasks and the priorities of those tasks. The user has the opportunity to easily update and modify their categories as well as their Hit List tasks and day to day priorities.

In one embodiment, the sub-location note taking areas could be modified to include voice recognition input and links to other file areas as well as be any shape size or color.

In one embodiment, the user plans their tasks according to the categories of thoughts and the perceived priorities of the thoughts as recorded and then places those tasks into the calendar, i.e., the tasks are first category centric rather than calendar centric. In this manner, the truly pressing items of the day are prioritized and completed prior to lesser pressing items that, in the absence of this invention, might simply get scheduled according to an open calendar slot and ahead of something more pressing, but that gets thought of or emerges a little while later.

In one embodiment, the present invention can also assist with managing completely separate areas of a person's life by providing two separate console single location areas, each corresponding to one separate and distinct area of the person's life. For example, a full-time working Mom could use the two different console single location thought recording areas within. the same planner to capture, visualize, manage, and balance all of the priorities pertaining to her full-time job and home life. The first console of note pads could be set-up to create, organize and prioritize all of her tasks and thoughts pertaining to her job as a Human Resources Director. Her categories might be designated as follows: “Boss/Gary”, “Direct Report/Anne”, “Direct Report/Kevin”, “Recruitment”, “Benefits”, “Employee Relations”, “Compensation”, “Special Projects”, “Phone Calls” and “Miscellaneous.” In addition, this console includes the important prioritizing note pad referred to as the “Hit List” which is integral to focusing her attention on her most pressing tasks. This device would also include a re-attachable calendar insert so she can view her upcoming events/appointments alongside her “work” console and make updates to appropriate note pad categories easily. The second console of notepads could be set-up similarly to create, organize and prioritize all of her tasks and thoughts pertaining to her ,role as a Mom. Her categories might be designated as follows: “Husband/Ken”, “Daughter/Kim”, “Son/Chris”, “Household”, “Vacations”, “Outside Errands, “Volunteer Assignments” and “Miscellaneous.” In addition, this “Mom” console includes the important prioritizing note pad referred to as the “Hit List” which is integral to focusing her attention on her most pressing tasks. This device also includes the same re-attachable calendar insert so she can view her upcoming events/appointments alongside either console and make updates to appropriate note pad categories easily. The console design of individual note pads allows her to quickly organize all of her tasks and ideas, view their relationship amongst each other, prioritize her most pressing tasks and then easily modify the console and “Hit List” at any given time in both areas of her life. When it is time to work on or think about her job, she can focus her attention on the “work” console. When it is time to work on or think about her home life, focus switches to the “Mom” console. It's a new, innovative way to capture and organize the totality of a person's tasks and thoughts as well as to hone their prioritization skills. Moreover, since both “Hit Lists” are removable, replaceable and repositionable, they can both be viewed simultaneously to determine if there is anything pressing in one area of her life that might trump a task in the other area of her life even though she is currently focused in that area. In this way, all things get balanced and prioritized appropriately.

### EXAMPLES

For clarity of disclosure, the following examples are based on specific users that would benefit from the device of the present invention. One of ordinary skill in the art will appreciate the many embodiments of the system of the present invention, for example, and not by way of limitation, adapted for other categories of users such as school aged children who would benefit from learning from the intuitive organizational techniques the device provides.

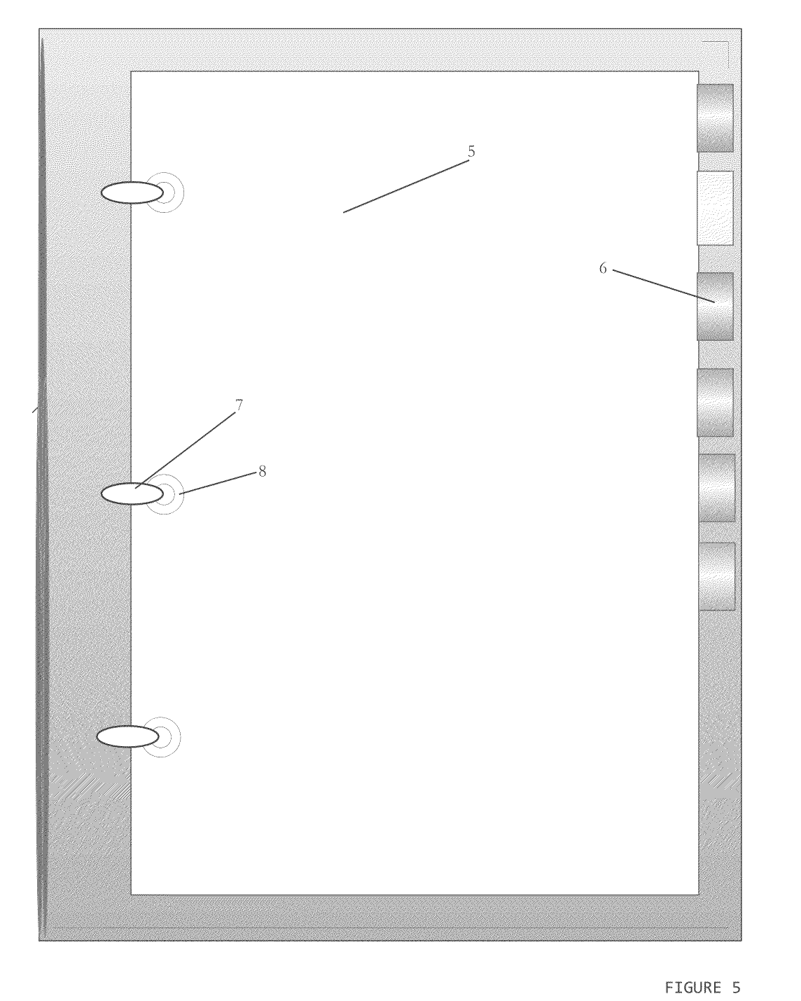

In one embodiment, the device of the present invention might be used by an attorney to organize his or her thoughts relating to their job. For example, one such thought area may be designated “litigation.” The attorney may be involved in a litigation representing ABC Corp. in a lawsuit against DEF Corp. The attorney just received DEF Corp.'s Answer to the Complaint and in reviewing the thought occurs that it is time to get out ABC Corp.'s first set of discovery requests. That thought can be recorded in the sub- location area designated “litigation.” While thinking about that, the attorney may think it is a good idea to have that new first year associate draft the set of discovery in the first instance to save time and give that associate a good learning experience, but that associate is on the phone at the moment. The attorney can record on the “Hit List” the note to ask that associate to draft the discovery. Just then, the president of XYZ Corp. calls and says that they thought about the recommendation and wants the attorney to file the Complaint that was drafted and discussed. In that telephone call, the president may also tell the attorney that the head of human resources, Jane Smith, wants to discuss an employment issue that came up. Thus, the attorney can use the device of the present invention to record the litigation task of filing the XYZ Corp. Complaint and to set up a meeting with Jane Smith. The Complaint filing task is recorded in the “litigation” sub-location and the meeting note is recorded in the “client meeting” sub-location. While the attorney was on the phone, two other calls came in and one email. One of the calls was from Jim regarding the settlement offer that was made. The other call was from John Jones requesting a meeting regarding a new product idea he has. The email was from Nancy wanting to set up a dinner. Last week, the attorney was already working on reviewing a licensing arrangement for M&O Corp. and a tenant lease where John Doe had proposed some revisions. All these things are recorded appropriately as reflected in FIG. 5. The attorney can then open up and view the console and create a Hit List of prioritized tasks. The settlement with Jim has been somewhat of a struggle and if there is a good communication to be had, better to strike while the iron's hot. Emailing Nancy back is easy and painless so best to just get that done. The M&O revisions are done; just need a quick final review and can get that off the plate. Would like to get the ABC Corp. discovery out soon so need to call the associate soon to get started. Not sure about those lease revision proposals and want a second opinion so ask another associate for a second opinion. In thinking about getting the XYZ Corp. Complaint filed, just realized there was one fact that was incomplete in the draft that a call is needed to finalize. By viewing all these tasks in context with each other, the prioritization is easy and all things get tended to. The call with John Jones can wait a little bit as he has a history of calling with lots of ideas that never lead to anywhere and he has not said it was pressing. Because all of the tasks are recorded, and all are viewable in a single location, all can be prioritized and none will get overlooked. Deadlines to get things accomplished may be added. As such deadlines approach, tasks that need to get done to meet that deadline will get added to the Hit List.

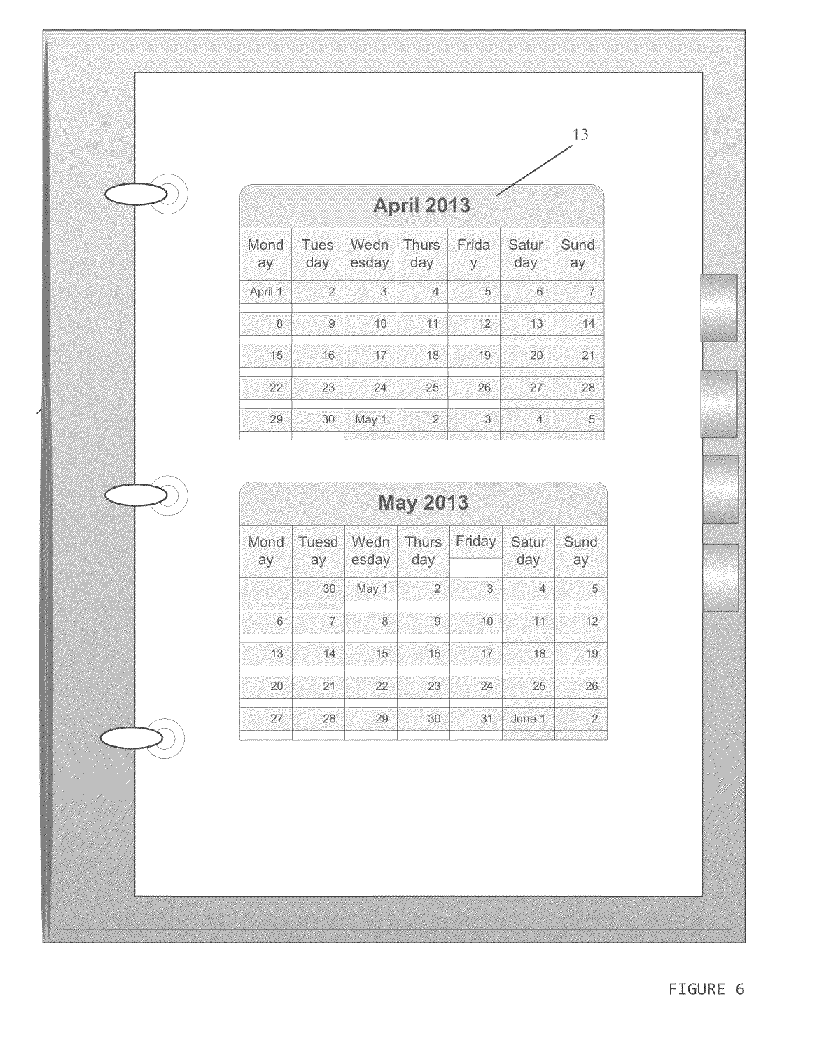

In the immediately preceding example, when things need notes that are more comprehensive than can be placed in the console, a separate area can be utilized for that task. Nevertheless, the thought and task are still recorded on the console. For example, with respect to the ABC Corp. needing to get out a set of discovery requests, that thought and task is recorded in the “litigation” sub-location area. The thought occurred to have an associate draft the set in the first instance. One of the tabbed areas in the other area for taking notes may be utilized to track the progress of such an extensive area of undertaking. Thus, specific parts of the discovery, i.e., Initial Disclosures, Interrogatories, Requests to Admit, and Requests to Produce can be tracked as to progress in this area. When the associate provides a draft, for example, they could be placed here for review. If certain specific thoughts occur that need to be included, they might first make the console, but then placed here to compare to the current draft to insure that that thought has been addressed in the draft. Thus, the console is the area where the initial thought is recorded, and the other areas for note taking can be utilized to record more in-depth analysis and progress with respect to certain projects. FIGS. 5 and 6 illustrate this interplay.

In one embodiment, a user may have a device of the present invention capable of use for any specific area of the user's life, for example, one for work and one for personal life.

In one embodiment, a user may simply use two console single location note taking areas within the same planner. For example, the device of the present invention might be used by a working Mom with a family and kids to organize her thoughts and familial obligations as well as her work obligations. For example, the full-time working Mom could use the two different console single location thought recording areas within the same planner to capture, visualize, manage, and balance all of the priorities pertaining to her full-time job and home life. The first console of note pads could be set-up to create, organize and prioritize all of her tasks and thoughts pertaining to her job as a Human Resources Director. Her categories might be designated as follows: “Boss/Gary”, “Direct Report/Anne”, “Direct Report/Kevin”, “Recruitment”, “Benefits”, “Employee Relations”, “Compensation”, “Special Projects”, “Phone Calls” and “Miscellaneous.” In addition, this console includes the important prioritizing note pad referred to as the “Hit List” which is integral to focusing her attention on her most pressing tasks. This device would also include a re-attachable calendar insert so she can view her upcoming events/appointments alongside her “work” console and make updates to appropriate note pad categories easily. The second console of notepads could be set-up similarly to create, organize and prioritize all of her tasks and thoughts pertaining to her role as a Mom. Her categories might be designated as follows: “Husband/Ken”, “Daughter/Kim”, “Son/Chris”, “Household”, “Vacations”, “Outside Errands, “Volunteer Assignments” and “Miscellaneous.” In addition, this “Mom” console includes the important prioritizing note pad referred to as the “Hit List” which is integral to focusing her attention on her most pressing tasks. This device also includes the same re-attachable calendar insert so she can view her upcoming events/appointments alongside either console and make updates to appropriate note pad categories easily. The console design of individual note pads allows her to quickly organize all of her tasks and ideas, view their relationship amongst each other, prioritize her most pressing tasks and then easily modify the console, and “Hit List” at any given time in both areas of her life. When it is time to work on or think about her job, she can focus her attention on the “work” console. When it is time to work on or think about her home life, focus switches to the “Mom” console. It's a new, innovative way to capture and organize the totality of a person's tasks and thoughts as well as to hone their prioritization skills. Moreover, since both “Hit Lists” are removable, replaceable and repositionable, they can both be viewed simultaneously to determine if there is anything pressing in one area of her life that might trump a task in the other area of her life even though she is currently focused in that area. In this way, all things get balanced and prioritized appropriately.

In this immediately preceding example, the Mom while at work can begin to populate all of her note pads with related thoughts and tasks that are already in her head, as they come up during the course of her day and as triggered when she reviews her upcoming calendar of events and appointments. “Boss/Gary” might contain thoughts such as: Update on new Employee Recognition Program, Update on status of discrimination claim, Discuss employee bonus allocation, Discuss Offsite Management Team Meeting, Review candidates for Creative Director post, and Request Vacation Week in May. “Direct Report/Anne” might contain thoughts such as: Send out reminder to Managers to schedule May Performance Reviews, Start Planning Holiday Party, Discuss Recruitment Plan for Summer Interns, and Coordinate re-organization of File Room. “Recruitment” might contain thoughts such as: Review Production Manager opening with Tom, Post job opening for Media Coordinator on a jobs website, Review resumes for Administrative Assistant, and Extend Job Offer to VP, Sales Director. “Miscellaneous” might contain thoughts that don't fit or warrant any one note pad such as: Schedule Exit Interview with Cecilia, Set up meeting with IT Department to review HR database, Call Payroll Company, or order flowers for CEO's birthday. Some of these thoughts may be urgent or pressing at the time she thinks about them. Some of these thoughts may be more long-term in nature or even thoughts that do not necessitate having any time-frame or deadline attached. However, rather than jotting them down on a calendar or a random list that may get buried or over-looked (or keeping them in her head because she has no place to put them and hoping to remember at an opportune time), she can record them in a place where she knows she won't lose sight of anything. She can place them within a category or directly on the “Hit List” depending on the urgency of each task. Once her customized console has been organized with tasks and thoughts pertaining to the full scope of her job, she can start to create and maintain a daily priority “Hit List” simply by reviewing the totality of her note pads and determining which tasks are the most pressing on that particular day. For example, her “Hit List” on Monday might have the following priorities outlined: Meet with Boss/Gary to discuss Offsite Management Meeting, Post Media Coordinator position, Extend Job offer to VP, Sales Director, and Meet with Anne to kick-off Holiday Party and Discuss Summer Interns. This “Hit List” becomes her daily compass as she focuses her time and energy on completing the most pressing tasks, while continually being able to readily assess their relationship with other tasks. For example, if her Direct Report/Anne calls in sick, she can easily update her “Hit List” by crossing off the related action items, adding new ones from other Categories or even tearing off the top page of the “Hit List” and creating an entirely new list. Or, if she gets a phone call from the company's Attorney with an urgent discrimination claim update, she may decide to quickly modify her “Hit List.”

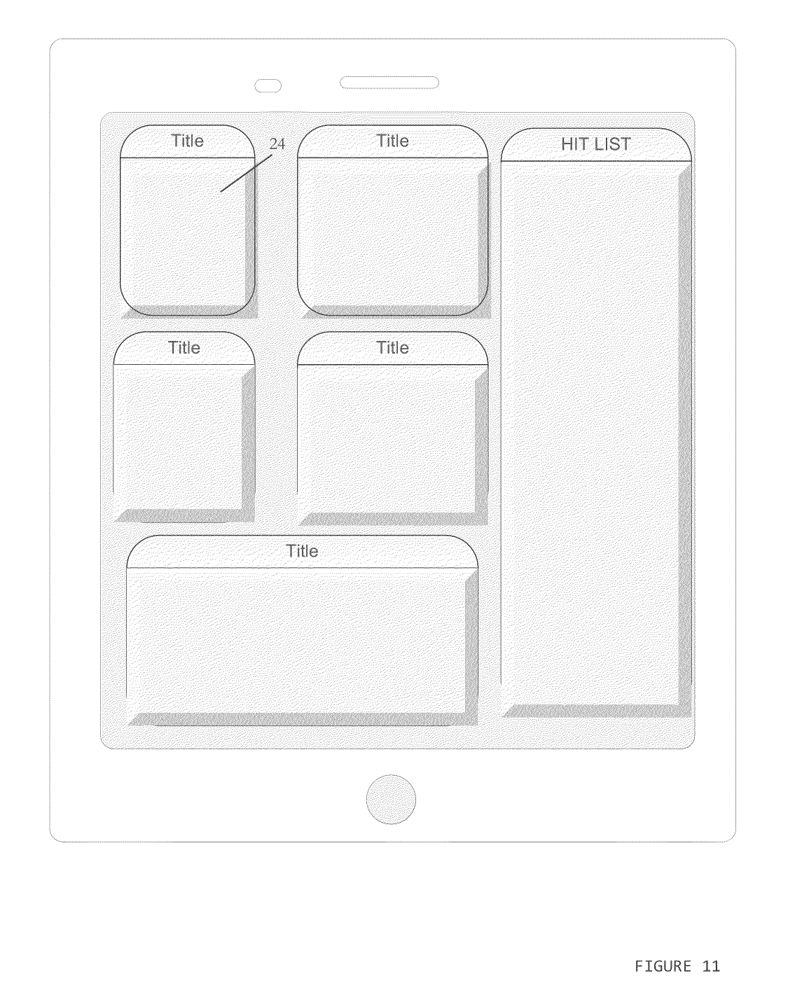

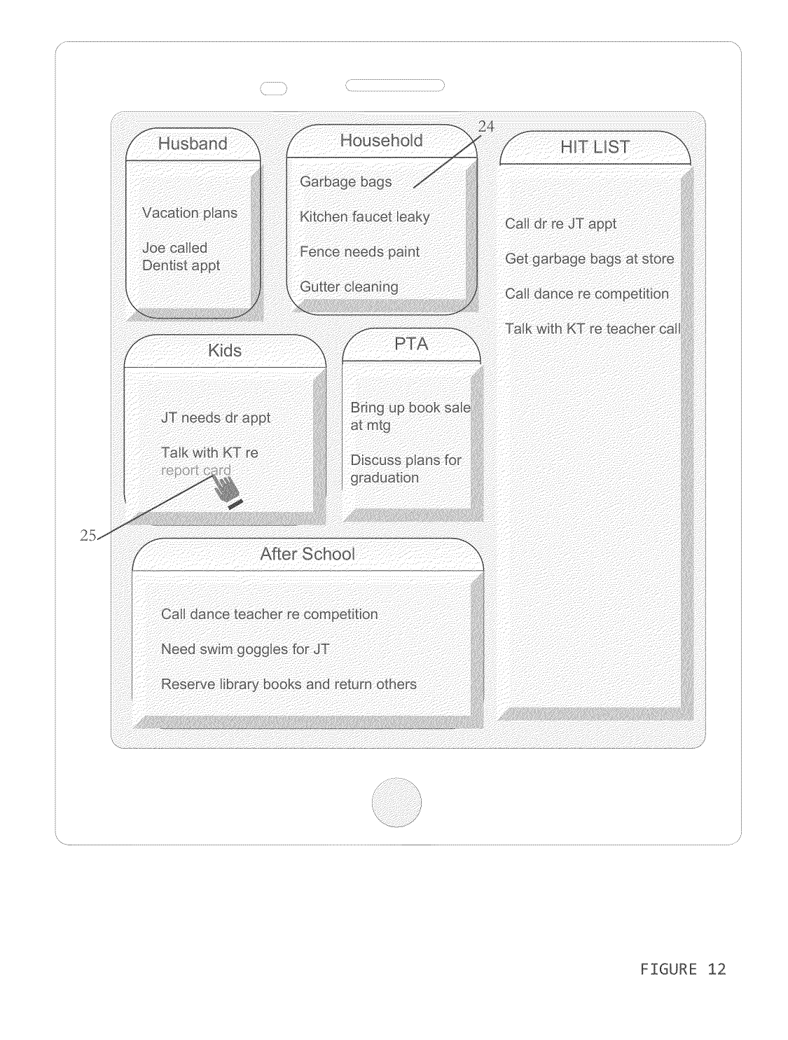

Continuing with this immediately preceding example, when Mom has her “home hat” on and needs to coordinate and balance her familial obligations, this Mom can begin to populate the second console single location note pads with related thoughts and tasks that are already in her head, as they come up during the course of her day and as triggered when she reviews her upcoming calendar of events and appointments. “Husband/Ken” might contain thoughts such as: Discuss updating our Will, Do we want to invite the Smiths over for dinner Saturday?, What should we do with our kids over Spring Break?, and Fence in the Apple Tree. “Household” might contain thoughts such as: Order patio furniture covers, Shop for new foyer rug, Select new paint color for Kitchen, and Purchase front stoop planters. “Miscellaneous” might contain thoughts that don't fit or warrant any one note pad such as: Research Audiologist, Submit insurance claims, Schedule Haircut, Buy birthday gift for friend, Research curling irons, and audit home cleaning supplies. Again, some of these thoughts may be urgent or pressing at the time she thinks about them. Some of these thoughts may be more long-term in nature or even thoughts that do not necessitate having any time-frame or deadline attached. However, rather than jotting them down on a calendar or a random list that may get buried or over-looked (or keeping them in her head because she has no place to put them and hoping she remembers them at an opportune time), she can record them in a place where she knows she won't lose sight of anything. She can place them within a category or directly on the “Hit List” depending on the urgency of each task. Certain tasks may require extra notes or materials. For example, a teacher may have sent a report card home and Mom wants to discuss with her daughter. She may then place on the console the need to discuss the report card and place the actual report card in the other area for note taking to retrieve when ready to discuss (or open up the separate file in the electronic version—See FIGS. 11 and 12). Once this second customized console single location note taking area has been organized with tasks and thoughts pertaining to the full scope of her role as a Mom, she can start to create and maintain a daily priority “Hit List” simply by reviewing the totality of her note pads and determining which tasks are the most pressing on that particular day. For example, her “Hit List” on Monday might have the following priorities outlined: Prepare Board Report for School Meeting, Sign up Son/Chris for Baseball Camp, Mail package at Post-office, Drop-off Dry-cleaning, Call Neighbor/Jane about dog sitting. This “Hit List” becomes her daily compass as she focuses her time and energy on completing the most pressing tasks, while continually being able to readily assess their relationship with other tasks. Moreover, it is easy to update and re-calibrate as her day/week progresses. For example, if her Board Meeting gets cancelled, she may remove the Board Report it from off her “Hit List”, add it back to “Volunteer Assignments” and replace it with another task. Moreover, as noted, since both the “work” and “Mom” “Hit Lists” are removable, replaceable and repositionable, they can both be viewed simultaneously to determine if there is anything pressing in one area of her life that might trump a task in the other area of her life even though she is currently focused in that area. In this way, all things get balanced and prioritized appropriately. Work Mom and Home Mom know that all things pressing at both work and home are organized and balanced and will not get forgotten or overlooked.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent.

Each and every feature described herein, and each and every combination of two or more of such features, is included within the scope of the present invention provided that the features included in such a combination are not mutually exclusive.

What is claimed is:

1. A personal organizer comprising:
a. a front and rear panel;
b. a first surface inside said front panel; and
c. a plurality of customizable recording areas positioned within said first surface; wherein
i. said customizable recording areas are capable of recording thoughts in a single planar and visible location in an organized manner; wherein
ii. such recordings of thoughts are used to generate a prioritized task plan.

2. The device of claim 1 where the customizable recording areas are repositionable note pads.

3. The device of claim 1 further comprising an at least one other area of paper for note taking.

4. The device of claim 1 further comprising a second surface immediately adjacent to said first surface inside said front panel such that said first surface and said second surface may combine to form a single larger surface.

5. The device of claim 1 further comprising a writing implement holder.

6. The device of claim 2 wherein any number of said plurality of repositionable note pads is replaced with a spiral note pad.

7. The device of claim 2 wherein any number of said plurality of repositionable note pads is replaced with any note recording surface area.

8. The device of claim 2 wherein any number of said plurality of repositionable note pads are of varying sizes and colors and shapes.

9. The device of claim 2 wherein one repositionable note pad is larger and more noticeable than any of the other repositionable note pads.

10. The device of claim 2 wherein the repositionable note pads are mounted on said mounting surface by way of hook and loop fastener in any orientation within the mounting surface.

11. The device of claim 3 wherein the at least one other area of paper for note taking includes a calendar.

12. The device of claim 3 wherein the at least one other area of paper for note taking includes an address book.

13. The device of claim 3 wherein the at least one other area of paper for note taking includes a contacts section.

14. The device of claim 3 wherein the at least one other area of paper for note taking accommodates the easy removal and replacement of loose leaf paper which are placed in tabbed sections.

15. The device of claim 4 wherein said first and second surface could be located anywhere between the front and rear panel that creates a substantially single location where said plurality of customizable recording areas are positioned.

16. The device of claim 9 wherein said one larger and more noticeable repositionable note pad is removable and mountable in any location on the device.

17. The device of claim 11 wherein the calendar is easily removable.

18. The device of claim 15 wherein there could be more than one such substantially single location for the mounting of said plurality of customizable recording areas

19. A method of recording, organizing and prioritizing one's thoughts and corresponding tasks by utilizing the device of claim 1 to perform the steps of: 1) emptying all of a user's thoughts onto the customizable recording areas into various user defined categories; 2) reviewing the recorded thoughts to generate a prioritized task plan; 3) recording the prioritized task plan onto one separate customizable recording area; and 4) updating each customizable recording area as new user thoughts are generated and tasks completed.
